(19) United States
(12) Patent Application Publication
(10) Pub. No.: US 2009/0161728 A1
(43) Pub. Date: Jun. 25, 2009

(54) SYSTEM AND METHOD FOR INTEGRATING MULTIPLE RADIOS OF DIFFERENT PROTOCOLS

(75) Inventors: Irfan NASIR, Lake in the Hills, IL (US); Kenneth CORNETT, Coral Springs, FL (US); Liliana GRAJALES, Chicago, IL (US); Lih-Tyng HWANG, Crystal Lake, IL (US); Andreas SCHALLER, Wiesbaden (DE); Aroon TUNGARE, Winfield, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/963,897

(22) Filed: Dec. 24, 2007

(51) Int. Cl. H04B 1/00; H04B 7/00; H04L 27/28

(52) U.S. Cl. 375/132; 370/310; 375/260; 375/140; 375/E01.033; 375/E01.002

(57) ABSTRACT

A method, apparatus, and electronic device for regulating communication are disclosed. A first radio 304 may execute a coordination communication operation using a coordination protocol. A coordinator layer 230 may determine an optimum protocol for a communication operation based on the coordination communication operation. A second radio 302 may use the optimum protocol.

### FIELD OF THE INVENTION

The present invention relates to a method and system for managing multiple communication protocols in a mobile communication device. The present invention further relates to using a coordination protocol to determine an optimum communication protocol.

### INTRODUCTION

When a mobile communications device connects to a telecommunications network, the device may follow a series of standard rules called a communications protocol. These rules may cover data representation, signaling, authentication, and error detection. These protocols allow for more efficient and faster communications.

One such protocol is Bluetooth®, used over wireless personal area networks (WPAN). Bluetooth® may be used to connect and exchange information between devices over a secure, short-range radio frequency. Another protocol is ZigBee. ZigBee® is a protocol stack developed based on task group 4 of working group 15 of the Institute of Electrical and Electronics Engineers (IEEE). ZigBee® was developed to be used with WPAN standards. ZigBee® operates on the industrial, scientific, and medical band. ZigBee® is considered to be a less expensive and a more power efficient alternative to other WPAN protocols.

### SUMMARY OF THE INVENTION

A method, apparatus, and electronic device for regulating communication are disclosed. A first radio may execute a coordination communication operation using a coordination protocol. A coordinator layer may determine an optimum protocol for a communication operation based on the coordination communication operation. A second radio may use the optimum protocol.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a handheld device that may be used to implement the communication protocol management method.

FIG. 2 illustrates in a block diagram a combined protocol telecommunication device.

FIG. 3 illustrates one embodiment of a device coordinating communication in separate protocols with distinct application structures.

FIG. 4 illustrates one embodiment of an integrated device coordinating communication in separate protocols with distinct application structures.

FIG. 5 illustrates in a flowchart one embodiment of a method for managing multiple protocols.

FIG. 6 may illustrate in a block diagram a profile of a coordination criteria.

FIG. 7 illustrates in a block diagram one embodiment of a coordination message for an frequency hopping spread spectrum protocol.

FIG. 8 illustrates in a block diagram one embodiment of a coordination message for a direct sequence spread spectrum protocol.

FIG. 9 illustrates in a block diagram one embodiment of a coordination message for an orthogonal frequency divisional multiplexing protocol.

FIG. 10 illustrates in a flow state diagram one embodiment of a method for using multiple radios.

FIGS. 11a-b illustrates in a block diagram and a timing diagram the interaction between telecommunications devices having multiple communication protocols.

FIG. 12 illustrates in a flow state diagram the interaction method between telecommunications devices having multiple communication protocols.

FIGS. 13a-b illustrate in a block diagram and a timing diagram the interaction between a telecommunications devices having multiple communication protocols and devices having each communication protocols.

FIG. 14 illustrates in a flow state diagram the interaction method between telecommunications devices having multiple communication protocols and devices having each communication protocols.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for regulating communication are disclosed. A first radio may execute a coordination communication operation using a coordination protocol. A coordinator layer may determine an optimum protocol for a communication operation based on the coordination communication operation. A second radio may use the optimum protocol.

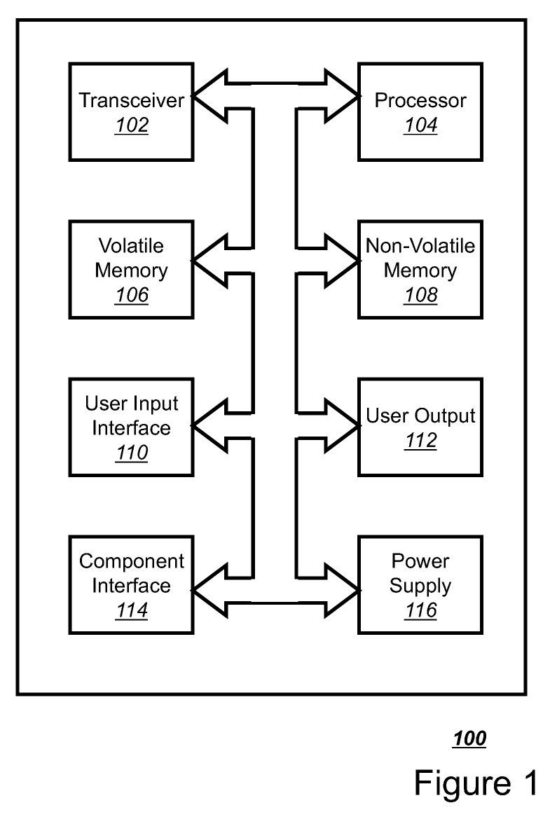

FIG. 1 illustrates in a block diagram one embodiment of a handheld device 100 that may be used to implement the communication protocol management method. While a handheld device is described, any computing device, such as a desktop computer or a server, may implement the communication protocol management method. The handheld device 100 may access the information or data stored in a network. The handheld device 100 may support one or more applications for performing various communications with the network. The handheld device 100 may implement any operating system, such as Windows or Linux, for example. Client and server software may be written in any programming language, such as C, C++, Java or Visual Basic, for example. The handheld device 100 may be a mobile phone, a laptop, a personal digital assistant (PDA), or other portable device. For some embodiments of the present invention, the handheld device 100 may be a WiFi capable device, which may be used to access the network for data or by voice using voice over internet protocol (VOIP).

The handheld device 100 may include a transceiver 102, such as a code division multiple access (CDMA) or a WiMax®, to send and receive data over the network. The handheld device 100 may further include one or more radios that operate under one or more protocols, such as Zigbee® or Bluetooth®.

The handheld device 100 may include a controller or processor 104 that executes stored programs. The controller or processor 104 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The handheld device 100 may also include a volatile memory 106 and a non-volatile memory 108 to be used by the processor 104. The volatile 106 and nonvolatile data storage 108 may include one or more electrical, magnetic or optical memories such as a random access memory (RAM), cache, hard drive, or other memory device. The memory may have a cache to speed access to specific data. The memory may also be connected to a compact disc-read only memory (CD-ROM), digital video disc-read only memory (DVD-ROM), DVD read write input, tape drive or other removable memory device that allows media content to be directly uploaded into the system.

The handheld device 100 may include a user input interface 110 that may comprise elements such as a keypad, display, touch screen, or any other device that accepts input. The handheld device 100 may also include a user output device that may comprise a display screen and an audio interface 112 that may comprise elements such as a microphone, earphone, and speaker. The handheld device 100 also may include a component interface 114 to which additional elements may be attached, for example, a universal serial bus (USB) interface or an audio-video capture mechanism. Finally, the handheld device 100 may include a power supply 116.

Client software and databases may be accessed by the controller or processor 104 from the memory, and may include, for example, database applications, word processing applications, video processing applications as well as components that embody the decision support functionality of the present invention. The user access data may be stored in either a database accessible through a database interface or in the memory. The handheld device 100 may implement any operating system, such as Windows or Linux, for example. Client and server software may be written in any programming language, such as ABAP, C, C++, Java or Visual Basic, for example.

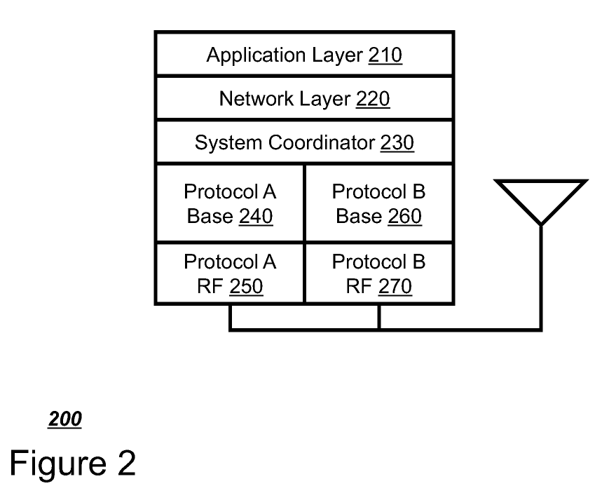

FIG. 2 illustrates in a block diagram a combined protocol telecommunication device 200. The combined protocol telecommunication device 200 may be integrated into the transceiver 102 of the handheld device 100 or connected to the handheld device 100 via the component interface 114. The application layer 210 may include the client application being run by the user, such as a web browser or other software application that requires a connection with a communications network. The network layer 220 may provide a secure connection to the communications network. The network layer 220 may provide source to destination transfer of data packets. The system coordinator 230 may determine which protocol is being used to connect to the telecommunications device 200 to the network. The telecommunication device 200 may have a radio for each of the protocols used by the telecommunication device 200, for example a Protocol A and Protocol B. The Protocol A base layer 240 may provide the base level data transmission of a network, to be encoded using the Protocol A radio frequency (RF) layer 250. The Protocol B base layer 260 may provide the base level data transmission of a network, to be encoded using the Protocol B RF layer 270.

The telecommunications device 100 may have a radio with a matching protocol for any necessity. For example, Protocol A may be a low data rate protocol, such as Zigbee®, with a transmission rate below 250 Kb of data per second. Protocol B may be a high data rate protocol, such as Bluetooth®, with a transmission rate above 250 Kb of data per second. Protocol A may have a low, sniff, or idle power mode, and Protocol B may have a high power mode. Protocol A may have a range of around 10 feet, while Protocol B may have a range of 100 feet. Protocol A may have a quality of service (QoS) with a low bit error ratio (BER), while Protocol B may have a high signal to noise ratio (SNR). Protocol A may have a fast discovery time, while Protocol B may have a long discovery time. Protocol A may use a mesh master-slave relation to create connectivity, and Protocol B may use a peer master-slave. Protocol A may have a different level of security compared with Protocol B. The system coordinator 230 may use a decision technique to determine which protocol to use, such as Bayesian algorithms, adaptive algorithms, optimization algorithms, or other algorithms.

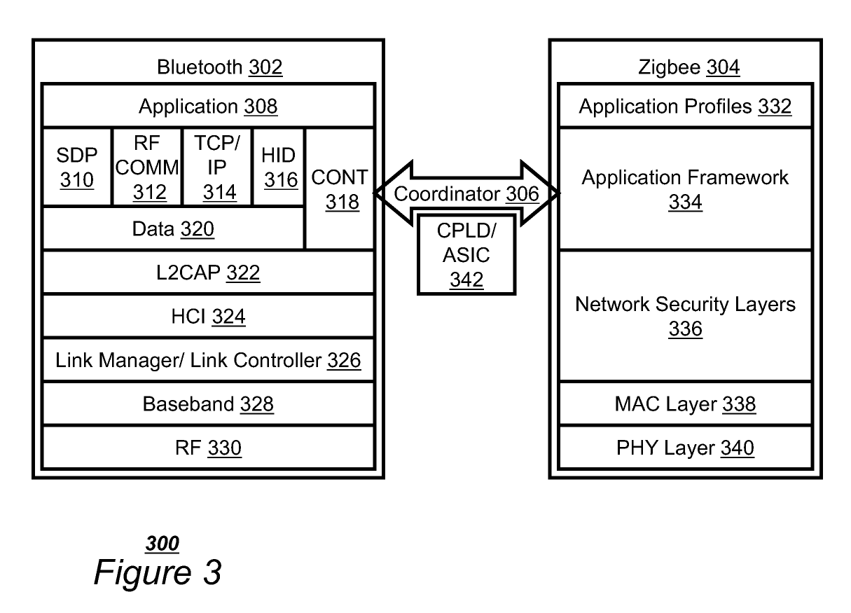

One type of protocol used may be a Bluetooth® or Zigbee® protocol. These multiple protocols may be managed in numerous ways. FIG. 3 illustrates one embodiment of a device 300 coordinating communication in separate protocols with distinct application structures. A Bluetooth® structure 302 and a Zigbee® structure 304 may interact using a coordinator layer 306.

The Bluetooth® structure 302 may have an application layer 308 for executing the client application being run by the user. The Bluetooth® structure 302 may have a service discovery protocol (SDP) 310 to discover available services and determine the characteristics of those services. The Bluetooth® structure 302 may have a radio frequency communication (RF COMM) protocol 312 to emulate serial ports to facilitate communication between layers. The Bluetooth® structure 302 may have a transmission control protocol and internet protocol (TCP/IP) 314 to provide internet encoding. The Bluetooth® structure 302 may have a human interface device (HID) 316 to allow a user to interact with the device. The Bluetooth® structure 302 may have control logic (CONT) 318 to manage data transmissions. The Bluetooth® structure 302 may have a data transmission layer 320 to receive data to be transmitted over a Bluetooth® connection. The Bluetooth® structure 302 may have a logical link control and adaptation protocol (L2CAP) 322 to provide connection services to upper layer protocols. The Bluetooth® structure 302 may have a host command interface (HCI) 324 to provide a command interface to the link manager/link controller 326 and the baseband layer 328. The link manager/link controller 326 may perform link set up, authentication, configuration, and other duties. The baseband layer 328 may provide the physical layer for Bluetooth transmissions. The Bluetooth® structure 302 may have a radio frequency (RF) layer 330 to define the requirements of the transceiver device.

The Zigbee® structure 304 may have an application profiles layer 332 to maintain a set of requirements for an application running on a Zigbee® structure 304. The applications framework 334 may transparently transfer data between the application profiles layer 332 and the network security layer 336, providing error recovery and flow control. The network security layer 336 may provide a secure connection to the network. The network security layer 336 may provide source to destination transfer of data packets. The media access control (MAC) layer 338 may provide addressing and channel accessing control mechanisms to communicate within a network. The MAC layer 338 may enact the necessary protocol to provide the connection from node to node in the network. The physical (PHY) layer 340 may provide the base level data transmission of a network. The general PHY layer 340 may include more than one specific PHY layer 340 parameters to control the transmissions.

The coordinator layer 306 may use the processor 104 of the handheld device 100 to compute any QoS parameters. The coordinator layer 306 may further use the processing capability of an application specific integrated circuit (ASIC) or a complex programmable logic device (CPLD) 342 associated with the device 300 to compute any QoS parameters.

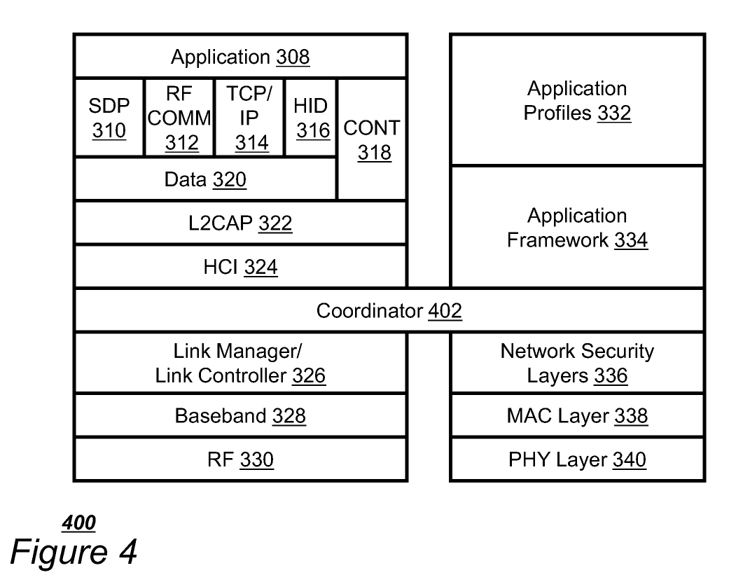

FIG. 4 illustrates one embodiment of an integrated device 400 coordinating communication in separate protocols with distinct application structures. The coordinator layer 402 may directly interface between the HCI protocol 324 and the link manager/link controller 326 of a Bluetooth® layer structure and between the application framework layer 334 and the network security layer 336 of a Zigbee® layer structure. The coordinator layer 402 may use the processor 104 of the handheld device 100 to compute QoS parameters. Further, the coordinator layer 402 may distribute these calculations among the baseband 328 of the Bluetooth® layer structure 302 and the MAC layer 338 of the Zigbee® layer structure 304.

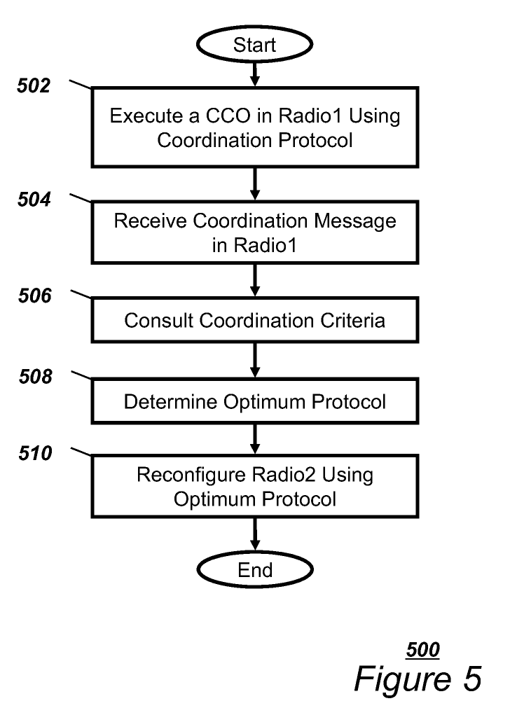

FIG. 5 illustrates in a flowchart one embodiment of a method 500 for managing multiple protocols. The combined protocol telecommunication device 200 may execute a coordination communication operation (CCO) in a first radio using a coordination protocol (Block 502). The coordination protocol may be a low power protocol, such as Zigbee®. The telecommunication device 200 may use the CCO to determine an optimum protocol for executing a communication operation. For example, the telecommunication device 200 may receive a coordination message in first radio (Block 504). The telecommunication device 200 may consult coordination criteria (Block 506). The telecommunication device 200 may determine an optimum protocol using the coordination message and the coordination criteria (Block 508). The telecommunication device 200 may reconfigure a second radio to use the optimum protocol (Block 510). The optimum protocol may be a high power protocol, such as Bluetooth®.

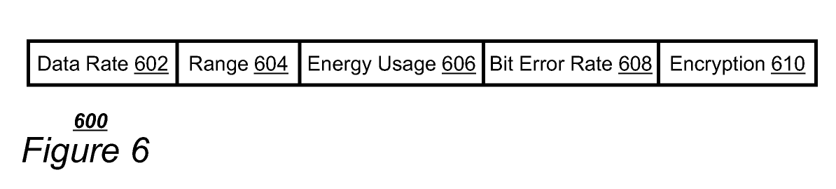

FIG. 6 may illustrate in a block diagram a profile 600 of a coordination criteria. The coordination criteria may include a data rate 602, range 604, energy usage 606, bit error rate 608, encryption 610, or other protocol characteristic.

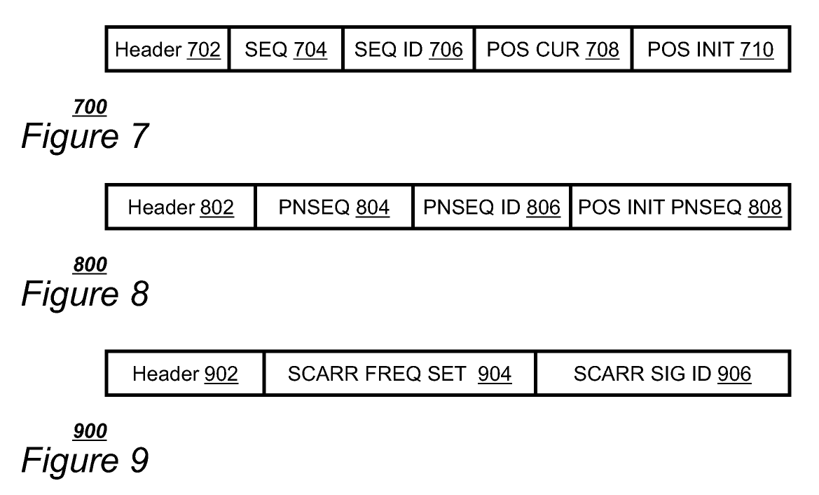

The optimum protocol may be a frequency hopping spread spectrum (FHSS) protocol, a direct sequence spread spectrum (DSSS) protocol, a protocol using multiple sub-carriers, an orthogonal frequency division multiplexing (OFDM) protocol, or other protocol. FIG. 7 illustrates in a block diagram one embodiment of a coordination message 700 for an FHSS protocol. A Bluetooth® radio may use an FHSS protocol. The coordination message 700 may contain a header 702 containing the address information for the coordination message 700. The coordination message 700 may contain a specific channel hopping sequence (SEQ) 704, an identifier specifying a known hopping sequences (SEQ ID) 706, a current position within a specified hopping sequence (POS CUR) 708, a starting position within the specified hopping sequence (POS INIT) 710, or other data.

FIG. 8 illustrates in a block diagram one embodiment of a coordination message 800 for a DSSS protocol. A Zigbee® may use a DSSS protocol. The coordination message 800 may contain a header 802 containing the address information for the coordination message 800. The coordination message 800 may contain a pseudo-noise spreading code sequence (PNSEQ) 804, an identifier specifying a pseudo-noise code sequence PNSEQ ID) 806, a start position within a specified pseudo-noise code (POS INIT PNSEQ) 808, or other data.

FIG. 9 illustrates in a block diagram one embodiment of a coordination message 900 for an OFDM protocol. The coordination message 900 may contain a header 902 containing the address information for the coordination message 900. The coordination message 900 may contain a set of sub-carrier frequencies (SCARR FREQ SET) 904, an identifier specifying a sub-carrier signal set (SCARR SIG ID) 906, or other data.

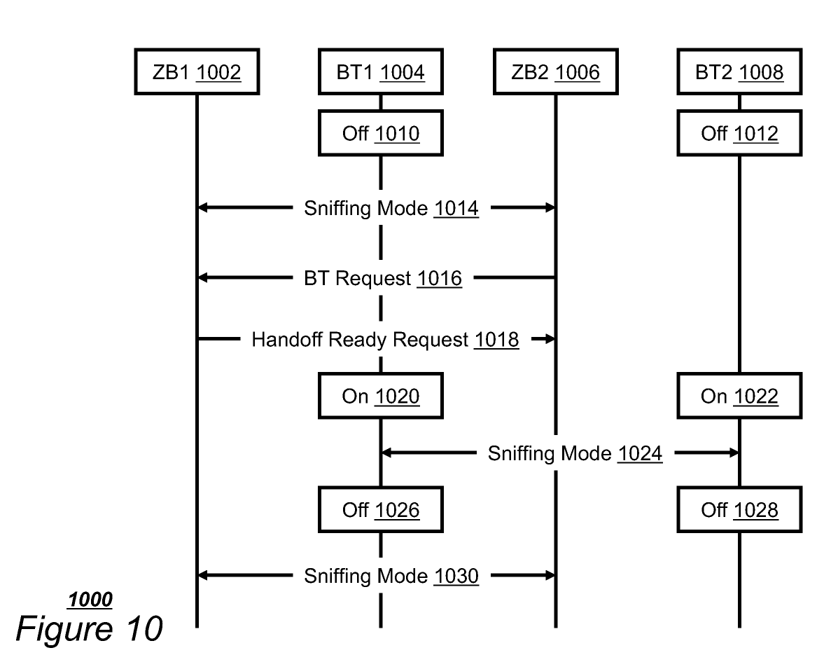

FIG. 10 illustrates in a flow state diagram one embodiment of a general method 1000 for using multiple radios. While Zigbee® and Bluetooth® are the protocols used in this example, any set of protocols may be used. A first Zigbee® (ZB1) radio 1002 and a first Bluetooth® (BT1) radio 1004 may connect with a second Zigbee® (ZB2) radio 1006 and a second Bluetooth® (BT2) radio 1008. The BT1 radio 1004 may be in an initial off state 1010 and the BT2 radio 1008 may be in an initial off state 1012. The ZB1 radio 1002 may be in a sniffing mode 1014 with the ZB2 radio 1006. The ZB2 radio 1006 may send a Bluetooth (BT) request 1016 to the ZB1 radio 1002. The ZB1 radio 1002 may send a handoff ready request 1018 to the ZB2 radio 1006. The BT1 radio 1004 may switch to an on state 1020 and the BT2 radio 1008 may switch to an on state 1022. The BT1 radio 1004 may be in a sniffing mode 1024 with the BT2 radio 1008. The BT1 radio 1004 may switch back to the off state 1026 and the BT2 radio 1008 switch back to the off state 1028 after the high power communication operation functions have been performed. The ZB1 radio 1002 may return to a sniffing mode 1030 with the ZB2 radio 1006.

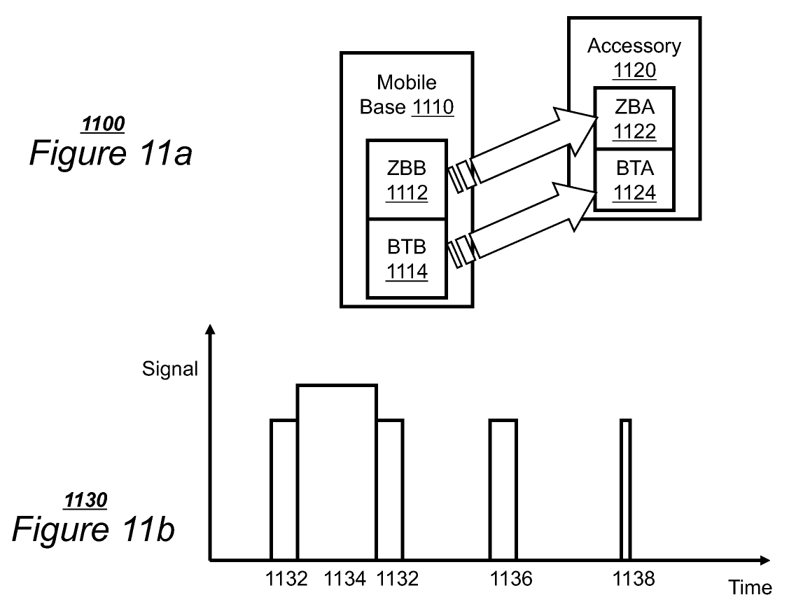

The multiple communication protocol telecommunication devices may create a connection 1100 with other telecommunications devices having multiple communication protocols, as shown in FIG. 11a. A mobile base device 1110 may have a Zigbee® base (ZBB) radio 1112 and a Bluetooth® base (BTB) radio 1114. The mobile base device 1110 may connect to an accessory device 1120. The accessory device 1120 may have a Zigbee® accessory (ZBA) radio 1122 and a Bluetooth® Accessory (BTA) radio 1124.

FIG. 11b illustrates a timing diagram 1130 of the communications between the mobile base device 1110 and the accessory device 1120. The ZBB radio 1112 may be active during the discovery period 1132 of the accessory device 1120. The BTB radio 1114 may then be active during the transmission period 1134 for heavy data transmission. The ZBB radio 1112 may be active during low data transmission periods 1136. The ZBB radio 1112 may be active during sniffing mode periods 1138.

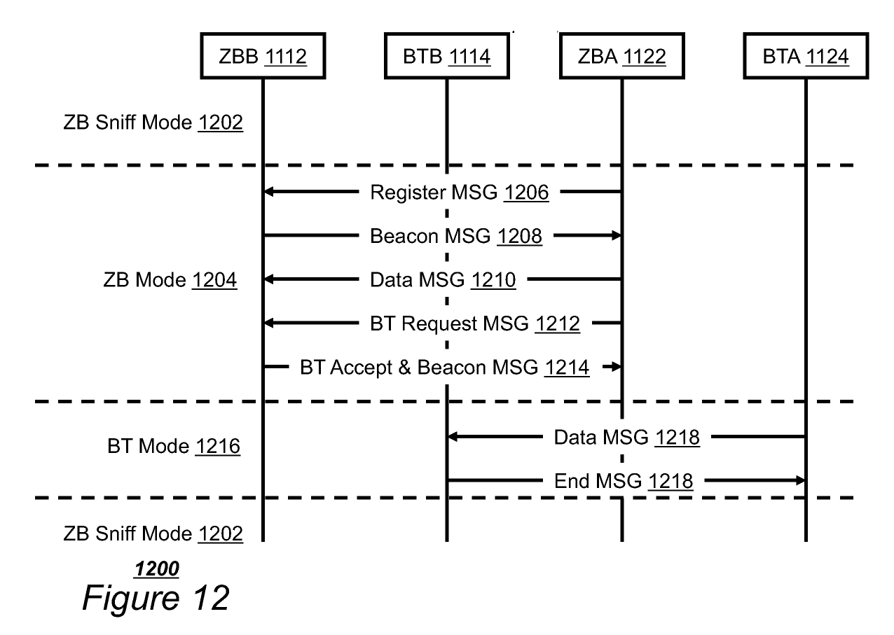

FIG. 12 illustrates in a flow state diagram the interaction method 1200 between telecommunications two devices each having multiple communication protocols. The devices are in Zigbee® (ZB) sniff mode 1202, until the ZBB radio 1112 detects the ZBA radio 1122. The devices then switch to ZB mode 1204. The ZBA radio 1122 may send a register message (MSG) 1206 to the ZBB radio 1112. The ZBB radio 1112 may reply with a beacon MSG 1208. The ZBA radio 1122 may send a data MSG 1210 and a Bluetooth® (BT) request MSG 1212 to the ZBB radio 1112. The ZBB radio 1112 may reply with a BT accept and beacon MSG 1214. The devices switch to BT mode 1216. The BTA radio 1124 sends a data MSG 1218 to the BTB radio 1114. The BTB radio 1114 may reply with an end MSG 1218 when the data transmission has concluded. The devices return to ZB sniff mode 1202.

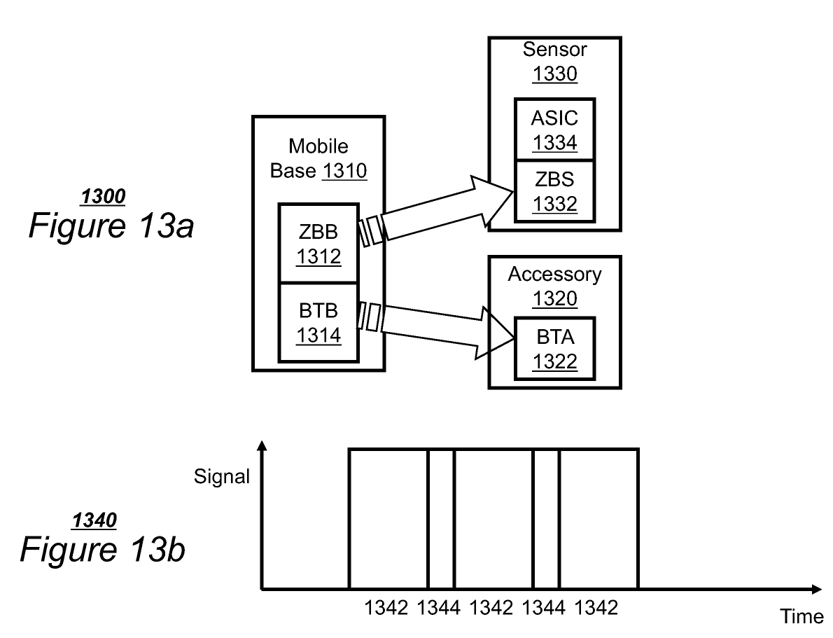

The multiple communication protocol telecommunication devices may create a connection 1300 with a telecommunications device for each communication protocol, as shown in FIG. 13a. A mobile base device 1310 may have a ZBB radio 1312 and a BTB radio 1314. The mobile base device 1310 may connect to an accessory device 1320. The accessory device 1320 may have a BTA radio 1124. The mobile base device 1310 may also connect to a sensor 1330, having a Zigbee® sensor (ZBS) radio 1332 and an ASIC 1334.

FIG. 13b illustrates a timing diagram 1340 of the communications between the mobile base device 1310, the accessory device 1320, and the sensor 1330. The BTB radio 1314 may exchange data during the BT mode period 1342 with the BTA radio 1322. The ZBB radio 1312 may exchange data during the ZB mode period 1344 with the ZBS radio 1332. The accessory 1320 may execute data during ZB mode period 1344 buffered during BT mode period 1342.

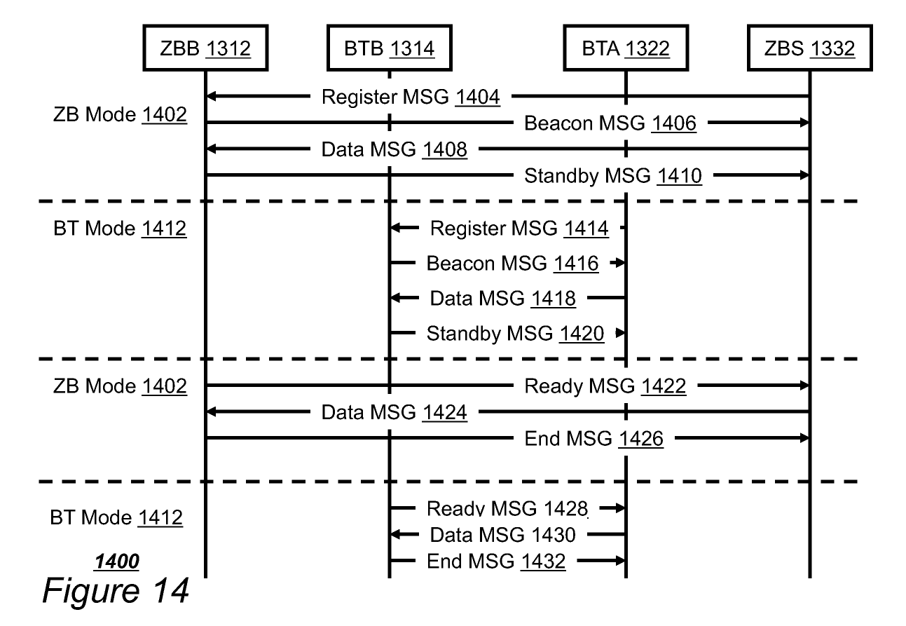

FIG. 14 illustrates in a flow state diagram the interaction method 1400 between a telecommunications device having multiple communication protocols and devices having each communication protocols. While the devices are in ZB mode 1402, the ZBS radio 1332 may send a register MSG 1404 to the ZBB radio 1312. The ZBB radio 1312 may reply with a beacon MSG 1406. The ZBS radio 1332 may send a data MSG 1408 to the ZBB radio 1312. The ZBB radio 1312 may reply with a standby MSG 1410. Switching to BT mode 1412, the BTA radio 1322 may send a register MSG 1414 to the BTB radio 1314. The BTB radio 1314 may reply with a beacon MSG 1416. The BTA radio 1322 may send a data MSG 1418 to the BTB radio 1314. The BTB radio 1314 may reply with a standby MSG 1420.

Switching back to ZB mode 1402, the ZBS radio 1312 may send a ready MSG 1422 to the ZBS radio 1332. The ZBS radio 1322 may reply with a data MSG 1424. The ZBB radio 1312 may send an end MSG 1426. Switching back to BT mode 1412, the BTB radio 1314 may send with a ready MSG 1416 to the BTA radio 1322. The BTA radio 1322 may reply with a data MSG 1430. The BTB radio 1314 may send an end MSG 1432.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for regulating communication comprising:
executing a coordination communication operation in a first radio using a coordination protocol;
executing a coordinator layer that determines an optimum protocol for a communication operation based on the coordination communication operation; and
reconfiguring a second radio using the optimum protocol.

2. The method of claim 1, further comprising determining the optimum protocol based on at least one of data rate, range, energy usage, bit error rate, or encryption.

3. The method of claim 1, further comprising:
receiving a coordination message with the first radio using the coordination protocol; and
using the coordination message to determine the optimum protocol.

4. The method of claim 3, wherein the optimum protocol uses a frequency hopping spread spectrum protocol.

5. The method of claim 4, wherein the coordination message includes at least one of a specific channel hopping sequence, an identifier specifying a known hopping sequences, a current position within a specified hopping sequence, or a starting position within the specified hopping sequence.

6. The method of claim 3, wherein the optimum protocol uses a direct sequence spread spectrum protocol.

7. The method of claim 6, wherein the coordination message includes at least one of a pseudo-noise spreading code sequence, an identifier specifying a pseudo-noise code sequence, or a start position within a specified pseudo-noise code.

8. The method of claim 3, wherein the optimum protocol uses an orthogonal frequency division multiplexing protocol.

9. The method of claim 8, wherein the coordination message includes at least one of a set of sub-carrier frequencies or an identifier specifying a sub-carrier signal set.

10. A telecommunications apparatus for regulating communication comprising:
a first radio that executes a coordination communication operation using a coordination protocol;
a coordinator layer that determines an optimum protocol for a communication operation based on the coordination communication operation; and
a second radio that uses the optimum protocol.

11. The telecommunications apparatus of claim 10, wherein the coordination layer determines the optimum protocol based on at least one of data rate, range, energy usage, bit error rate, or encryption.

12. The telecommunications apparatus of claim 10, wherein the first radio receives a coordination message using the coordination protocol and using the coordination message to determine the optimum protocol.

13. The telecommunications apparatus of claim 12, wherein the optimum protocol uses a frequency hopping spread spectrum protocol.

14. The telecommunications apparatus of claim 13, wherein the coordination message includes at least one of a specific channel hopping sequence, an identifier specifying a known hopping sequences, a current position within a specified hopping sequence, or a starting position within the specified hopping sequence.

15. The telecommunications apparatus of claim 12, wherein the optimum protocol uses a direct sequence spread spectrum protocol.

16. The telecommunications apparatus of claim 15, wherein the coordination message includes at least one of a pseudo-noise spreading code sequence, an identifier specifying a pseudo-noise code sequence, or a start position within a specified pseudo-noise code.

17. The telecommunications apparatus of claim 10, wherein the coordinator layer includes a processor and a media access control layer processor of the first radio that calculate a quality of service parameter.

18. The telecommunications apparatus of claim 10, wherein the coordinator layer includes a processor and an application specific integrated circuit that calculate a quality of service parameter.

19. An electronic device for regulating communication comprising:
a first radio that receives a coordination message using a coordination protocol and using the coordination message to determine the optimum protocol;
a coordinator layer that uses the coordination message to determine an optimum protocol for executing a function of a communication operation; and
a second radio that uses the optimum protocol.

20. The electronic device of claim 19, wherein the coordination protocol uses at least one of a frequency hopping spread spectrum protocol, a direct sequence spread spectrum protocol, and an orthogonal frequency divisional multiplexing protocol.
